(19) United States
(12) Patent Application Publication
(10) Pub. No.: US 2014/0344437 A1
(43) Pub. Date: Nov. 20, 2014

(54) METHOD AND SYSTEM FOR IMPLEMENTING A TRANSPARENT PROXY OF AN IOS SYSTEM

(71) Applicant: Tencent Technology (Shenzhen) Company limited, Shenzhen (CN)

(72) Inventor: Jiangquan Huang, Shenzhen (CN)

(21) Appl. No.: 14/449,330

(22) Filed: Aug. 1, 2014

Related U.S. Application Data
(63) Continuation of application No. PCT/CN2014/072800, filed on Mar. 3, 2014.

(30) Foreign Application Priority Data
Mar. 4, 2013 (CN) 201310067361.3

(51) Int. Cl. H04L 29/08

(52) U.S. Cl. CPC H04L 67/2814
USPC 709/223

(57) ABSTRACT

A method and a system for implementing a transparent proxy in an iOS system are disclosed. The method includes: sending a network request directed to a network server by a first module in the iOS system; intercepting the network request by a second module in the iOS system and forwarding the network request to a proxy server; receiving, by the second module, data content returned by the proxy server responding to the network request; and performing, by the second module, parsing processing on the data content and returning the processed data content to the first module.

### REFERENCE TO PRIOR APPLICATIONS

This application is a continuation of International Application No. PCT/CN2014/072800 filed on Mar. 3, 2014, which claims priority to Chinese Patent Application No. 201310067361.3, with a title of “METHOD AND SYSTEM FOR IMPLEMENTING TRANSPARENT AGENT OF IOS SYSTEM”, filed on Mar. 4, 2013 with the State Intellectual Property Office of China, the entire disclosures of which are herein incorporated by reference.

### TECHNICAL FIELD

The present disclosure relates to a technical field of transparent agent, and in particular relates to a method and a system for implementing a transparent proxy of an iOS system.

### BACKGROUND

Recently, a proxy technique has got a wide application in the field of the Internet technique. A proxy server applied in the proxy technique is an important security function. An operation of the proxy server is mainly performed between a client and a target network server. so that the proxy server functions as a firewall and further implements functions such as forwarding of a request conversion of a format of a webpage, adaptation, compression of resources, or the like. The proxy server is mainly used to connect an international internet and a local wireless network (LAN). Currently, in an iOS platform of the Apple Corporation, when wireless networks are set, setting of the proxy server can be performed for a certain wireless network. This manner needs a user using an iOS terminal to perform the setting, thus this proxy technique belongs to a non-transparent proxy technique.

A transparent proxy technique is opposite to the non-transparent proxy technique. A transparent proxy is a proxy mode in which the proxy server is only applied to a certain third party application (App for short) running in an electronic device and the proxy server is invisible to a user using the electronic device and other applications. Currently, the transparent proxy can be implemented by modifying a proxy setting of an application through a private application programming interface (API for short).

However, there is at least a following problem in the conventional transparent proxy technique: the manner for implementing the transparent proxy on the iOS platform by the private API does not satisfy a development protocol of iOS, so that the implementation of the transparent proxy on the iOS platform is relatively complicate.

### SUMMARY

According to an embodiment of the present disclosure, there is provided a method for implementing a transparent proxy of an iOS system, comprising: sending a network request directed to a network server by a first module (e.g. a NSURLConnection module) in the iOS system; intercepting the network request by a second module (e.g. a NSURLProtocol module) in the iOS system and forwarding the network request to an proxy server; receiving, by the second module, data content returned by the proxy server responding to the network request; and performing, by the second, module, parsing processing on the data content and returning it to the first module.

According to another embodiment of the present disclosure, there is provided a system for implementing a transparent proxy in an iOS system, comprising a first module (e.g. a NSURLConnection module), a second module (e.g. a NSURLProtocol module) and a proxy server, wherein the first module is configured to send a network request directed to a network server; the second module is configured to intercept the network request and forwarding the network request to the proxy server, receive data content returned by the proxy server responding to the network request, and performing parsing processing on the data content and returning it to the first module.

In the method and the system for implementing the transparent proxy in the iOS system, interception of the network request may be implemented by the first module (e.g. the NSURLProtocol module) provided in the iOS system. and the network request is sent to the proxy server, so that the proxy server returns the data content, while the entire procedure does not need an operation of the user, which achieves an object of the transparent proxy and implements the transparent proxy at an application level while satisfying the development protocol of the iOS.

### BRIEF DESCRIPTION OF THE DRAWINGS

In order to explain technical solutions of embodiments of the present disclosure clearer, accompanying drawings to be used in the description of the embodiments are described briefly below. It is obvious that the accompanying drawings in the following description show only some embodiments of the present disclosure, and for those skilled in the art, other accompanying drawings can be obtained according to these accompanying drawings without any inventive labor.

FIG. 1 is a flow chart of a method for implementing a transparent proxy in an iOS system provided by an embodiment of the present disclosure.

FIG. 2 is a flow chart of a method for implementing a transparent proxy in an iOS system provided by another embodiment of the present disclosure.

FIG. 3 is a schematic diagram of a structure of a system for implementing a transparent proxy in an iOS system corresponding to the method for implementing the transparent proxy in the iOS system shown in FIG. 1, provided by an embodiment of the present disclosure.

FIG. 4 is a schematic diagram of a structure of a system for implementing a transparent proxy in an iOS system corresponding to the method for implementing the transparent proxy in the iOS system shown in FIG. 2, provided by another embodiment of the present disclosure.

FIG. 5 shows a structural diagram of a terminal apparatus.

### DETAILED DESCRIPTION

The technical solutions of the embodiments of the present disclosure are described clearly and completely in combination with the accompanying drawings in the embodiments of the present disclosure hereinafter, and it is obvious that the described embodiments are only a part of the embodiments of the present disclosure, instead of all of the embodiments. All other embodiments obtained by those skilled in the art based on the embodiments in the present disclosure without the inventive labor belong to the scope sought for protection by the present disclosure.

In order to make the technical solutions of the present disclosure clearer, the present disclosure is described in detail in combination with the accompanying drawings and the embodiments hereinafter.

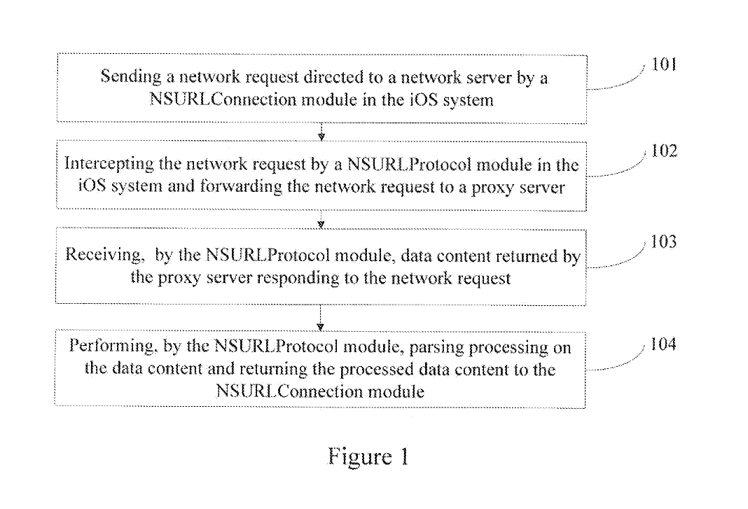

As shown in FIG. 1, the method for implementing the transparent proxy in the iOS system provided by the embodiment of the present disclosure includes steps as follows.

In step 101, an NSURLConnection module (i.e. a first module) in the iOS system may send a network request directed to a network server.

Here, the network request is used for requesting data content from the network server.

In particular, in the iOS platform, the NSURLConnection module may be used for downloading data content at a webpage address, providing a simple interface creation or abandoning a connection to the network server, and may be used for feedback and control in the process of connecting to the network server.

The network server is a server corresponding to the network request. For example, if the network request sent by the NSURLConnection module is to request to load a webpage address, the network server is a server corresponding to the webpage address.

In step 102, an NSURLProtocol module (i.e. a second module) in the iOS system may intercept the network request and forwards the network request to the proxy server.

In particular, the NSURLProtocol module can carry out a buffering operation on data in the iOS platform generally, can intercept the network request, and can forward the network request to the proxy server.

In step 103, the NSURLProtocol module receives data content returned by the proxy server responding to the network request.

In particular, the data content at the proxy server may be data content buffered in the proxy server in advance, or may be data content acquired by the proxy server from the network server after the network request.

It needs to be explained that, the interception of the network request by the NSURLProtocol module is only applied inside a third party application (Application, App for short), and does not influence network connections of other applications on the iOS platform. The third party application may be a browser, an application capable of opening a webpage, or the like, but is not limit thereto.

In step 104, the NSURLProtocol module may perform a parsing processing on the data content and returns it to the NSURLConnection module.

In particular, the NSURLConnection module is not able to know whether the parsed data content comes from the proxy server or the network server at the time of receiving the parsed data content, thereby the transparent proxy is achieved.

In the method and the system for implementing the transparent proxy according to the embodiment of the present disclosure, interception of the network request is implemented by the NSURLProtocol module provided in the iOS system, and the network request is sent to the proxy server, so that the proxy server returns the data content, meanwhile the entire process does not need the operation of the user, which implements the transparent proxy at the applications level while satisfying the development protocol of the iOS.

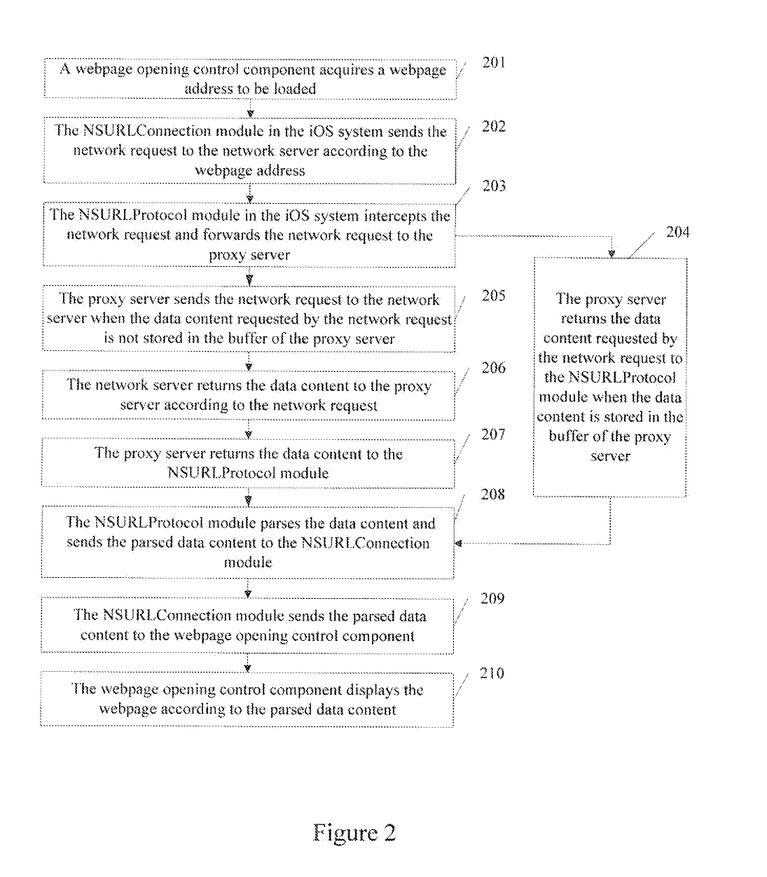

As shown in FIG. 2, a method for implementing a transparent proxy in the iOS system provided by another embodiment of the present disclosure includes steps as follows.

In step 201, a webpage opening control component may acquire a webpage address to be loaded.

In particular, the webpage opening control component (UIWebView) is a most used control component in a software development kit for the iOS system platform, and is an in-built browser control component which can be used to browse a webpage, open a document, or the like.

In particular, the webpage opening control component may include an input box for inputting a webpage address provided outwards, and it may acquire the webpage address after the webpage address is inputted into the input box, but it is not limited thereto.

In step 202, the NSURLConnection module in the iOS system may send the network request to the network server according to the webpage address.

Here, the network request is used for requesting data content from the network server, The data content may he used by the webpage opening control component to display the webpage.

In particular, in the iOS platform, the NSURLConnection module is used for downloading data content at a webpage address, providing a simple interface creation or abandoning a connection to the network server, and may be used for feedback and control in the process of connecting to the network server.

The network server is a server corresponding to the network request. For example, if the network request sent by the NSURLConnection module is to request to load a webpage address, the network server is a server corresponding to the webpage address.

In step 203, the NSURLProtocol module in the iOS system may intercept the network request and forwards the network request to the proxy server. Then, step 204 or step 205 is executed.

In particular, the NSURLProtocol module can carry out a buffering operation on data in the iOS platform generally, can intercept the network request, and can forward the network request to the proxy server.

Here, the NSURLProtocol module can implement a function of loading a webpage address URL through an underlayer application programming interface (Application Programming Interface, API for short) of the iOS system. Further, after the network request of the NSURLConnection is intercepted by the NSURLProtocol, the network request can be forwarded to the proxy server by ASIRequest in a third party Uniform Resource Locator (URL) loading library, in addition to implementing the function of loading the URL by the underlayer API of the iOS system. In particular, implementing the loading of the webpage address URL by the underlayer API of the iOS system is relatively cumbersome and complicate. Therefore, if the network request is forwarded by the ASIRequest in the third party URL loading library, the network communication is simplified, and convenient tools such as a tile uploading tool, a redirection processing tool, a verification tool, or the like are provided, so as to simplify transmission of the network request.

Here, the NSURLProtocol module keeps a long-time connection (e.g. a persistent connection) with the proxy server, in particular, by opening a connection multiplexing capacity of the network connection and keeping the long-time connection with the proxy server, time taken for loading a webpage can be reduced and a speed for loading the webpage can be increased.

It is to be explained that, the interception of the network request by the NSURLProtocol module is only applied inside the third party application (Application, App for short) and does not influence network connections of other applications on the iOS platform, so as to implement the transparent proxy at the application level in a subsequent process. The third party application may be a browser, an application capable of opening a webpage, or the like, but is not limited thereto. The above-described transparent proxy at the application level refers to that the process of the transparent proxy is only directed to a single application, instead of other applications in the iOS system.

In step 204, the proxy server may return the data content requested by the network request to the NSURLProtocol module when the data content is stored in a buffer of the proxy server. Then, step 208 is executed.

In step 205, the proxy server may send the network request to the network server when the data content requested by the network request is not stored in the buffer of the proxy server.

In step 206, the network server may return the data content to the proxy server according to the network request.

In step 207, the proxy server may return the data content to the NSURLProtocol module. Then, step 208 is executed.

In step 208, the NSURLProtocol module may parse the data content and send the parsed data content to the NSURLConnection module.

In particular, the NSURLConnection module is not able to know whether the parsed data content comes from the proxy server or the network server at the time of receiving the parsed data content, thereby the transparent proxy is achieved.

In step 209, the NSURLConnection module may send the parsed data content to the webpage opening control component.

In step 210, the webpage opening control component displays the webpage according to the parsed data content.

In the method for implementing the transparent proxy according to another embodiment of the present disclosure, interception of the network request is implemented by the NSURLProtocol module provided in the iOS system, and the network request is sent to the proxy server, so that the proxy server returns the data content, meanwhile the entire process does not need the operation of the user, which implements the transparent proxy at the application level while satisfying the development protocol of the iOS.

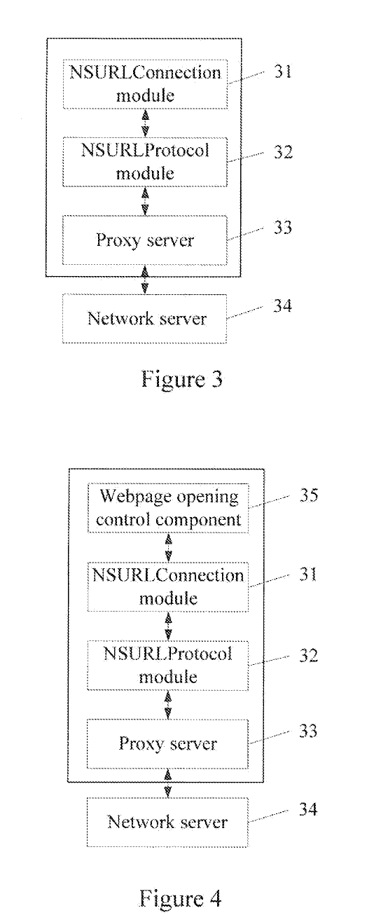

As shown in FIG. 3, a system for implementing a transparent proxy of an iOS system provided by an embodiment of the present disclosure may include a NSURLConnection module (i.e. a first module) 31, a NSURLProtocol module (i.e. a second module) 32, and an proxy server 33.

The NSURLConnection module 31 is configured to send a network request directed to a network server 34. A specific implementation mode thereof is the same as that described with respect to step 101 shown in FIG. 1, and a description thereof is omitted here.

The NSURLProtocol module 32 is configured to intercepting the network request and forwarding the network request to the proxy server 33. A specific implementation mode thereof is the same as that described with respect to step 102 shown in FIG. 1, and a description thereof is omitted here.

The NSURLProtocol module 32 is further configured to receive data content returned by the proxy server 33 responding to the network request. A specific implementation mode thereof is the same as that described with respect to step 103 showing in FIG. 1, and a description thereof is omitted here.

The NSURLProtocol module 32 is further configured to perform parsing processing on the data content and return it to the NSURLConnection module 31.

In particular, as shown in FIG. 4, the NSURLProtocol module 32 is specifically configured to forward the network request to the proxy server 33 through ASIRequest in a third party Uniform Resource Locator (URL) loading library.

In particular, the NSURLProtocol module 32 keeps a long-time connection with the proxy server 33.

In particular, as shown in FIG. 4, the system may further include a webpage opening control component 35.

The NSURLProtocol module 32 is further configured to parse the data content and send the parsed data content to the NSURLConnection module 31.

The NSURLConnection module 31 is further configured to send the parsed data content to the webpage opening control component 35.

The webpage opening control component 35 is configured to display a webpage according to the parsed data content.

Further, as shown in FIG. 4, the proxy server 33 is further configured to send the network request to the network server 34 when the data content requested by the network request is not stored in a buffer of the proxy server 33.

The network server 34 is further configured to return the data content to the proxy server 33 according to the network request.

In particular, a specific implementation mode of the system for implementing the transparent proxy in the iOS system provided by the embodiments of the present disclosure can be the same as that described with respect to the specific embodiment of the method for implementing the transparent proxy in the iOS system in FIG. 2, and a description thereof is omitted here.

In the system for implementing the transparent proxy according to the embodiment of the present disclosure, interception of the network request is implemented by the NSURLProtocol module provided in the iOS system, and the network request is sent to the proxy server, so that the proxy server returns the data content, meanwhile the entire process does not need the operation of the user, which implements the transparent proxy at the application level while satisfying the development protocol of the iOS.

It is to be noted that, in the specification, the terms “comprise”, “include” and any other variation thereof intend to cover nonexclusive inclusion, so that a process, a method, a product or a device including a series of elements not only include these elements, but also include other elements which are not listed explicitly, or inherent elements of the process, the method, the product or the device. In a case where there is not a further limitation, an element defined by an expression “include/comprise one . . . ” does not exclude additional identical elements existing in the procedure, the method, the product or the device including the element.

The sequence numbers of the above-described embodiments of the present disclosure is only for description, and does not represent preference of the embodiments.

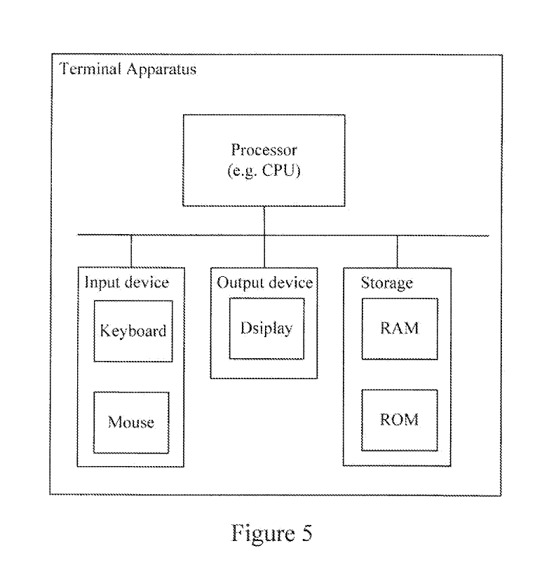

With the description of the above embodiments, those skilled in the art can understand clearly that, the methods according to the above embodiments can be implemented by means of software plus a necessary general-purpose hardware platform, and of course can be implemented by hardware; however, in many cases, the former is a better implementation mode. Based on such understanding, the technical solutions of the present disclosure essentially or a part of the technical solutions of the present disclosure which makes contribution to the related art can be embodied in a form of a software product, and the computer software product is stored in a non-transitory storage medium, such as a ROM/RAM, a magnetic disc, an optical disk or the like, and includes some instructions to cause a terminal apparatus as shown in FIG. 5, which may be a mobile phone, a computer, a server, a network equipment, or the like to execute the methods according to the respective embodiments of the present disclosure.

What are described above are only specific embodiments of the present disclosure, and the scope sought for protection by the present disclosure is not limited thereto. Those skilled in the art can contemplate variations or replacements easily in the technical scope disclosed in the present disclosure, and these variations or replacements fall within the scope sought for protection by the present disclosure. Therefore, the protection scope of the present disclosure is defined by the attached claims.

What is claimed is:

1. A method for implementing a transparent proxy in an iOS system, comprising:
sending a network request directed to a network server by a first module in the iOS system;
intercepting the network request by a second module in the iOS system and forwarding the network request to a proxy server;
receiving, by the second module, data content returned by the proxy server responding to the network request; and
performing, by the second module, parsing processing on the data content and returning the processed data content to the first module.

2. The method of claim 1, wherein
the second module forwards the network request to the proxy server by ASIRequest in a third party Uniform Resource Locator (URL) loading library.

3. The method of claim 2, wherein the second module keeps a longtime connection with the proxy server.

4. The method of claim 3, wherein after the second module performs the parsing processing on the data content and returns it to the first module,
the first module sends the parsed data content to a webpage opening control component; and
the webpage opening control component displays a webpage according to the parsed data content.

5. The method of claim 4, wherein after the second module intercepts the network request and forwards the network request to the proxy server,
the proxy server sends the network request to the network server when the data content requested by the network request is not stored in a buffer of the proxy server; and
the network server returns the data content to the proxy server according to the network request.

6. The method of claim 1, wherein the first module is an NSURLConnection module, and the second module is an NSURLProtocol module.

7. A system for implementing a transparent proxy in an iOS system, comprising: a first module, a second module and a proxy server, wherein
the first module is configured to send a network request directed to a network server; and
the second module is configured to intercept the network request and forward the network request to the proxy server, receive data content returned by the proxy server responding to the network request, and perform parsing processing on the data content and return the processed data content to the first module.

8. The system of claim 7, wherein the second module is configured to forward the network request to the proxy server through ASIRequest in a third party Uniform Resource Locator (URL) loading library.

9. The system of claim 8, wherein the second module keeps a long-time connection with the proxy server.

10. The system of claim 9, further comprising a webpage opening control component, wherein
the first module is further configured to send the parsed data content to the webpage opening control component; and
the webpage opening control component is configured to display a webpage according to the parsed data content.

11. The system of claim 10, wherein the proxy server is further configured to send the network request to the network server when the data content request by the network request is not stored in a buffer of the proxy server; and
the network server is further configured to return the data content to the proxy server according to the network request.

12. The system of claim 7, wherein the first module is an NSURLConnection module, and the second module is an NSURLProtocol module.

13. A non-transitory computer-readable storage medium having computer instructions stored thereon, the computer instructions, when executed by a computer, causing the computer to:
send a network request directed to a network server by a first module in an iOS system;
intercept the network request by a second module in the iOS system and forwarding the network request to a proxy server;
receive, by the second module, data content returned by the proxy server responding to the network request; and
perform, by the second module, parsing processing on the data content and returning the processed data content to the first module.

14. The non-transitory computer-readable storage medium of claim 13, wherein the first module is an NSURLConnection module, and the second module is an NSURLProtocol module.
